(19) United States
(12) Patent Application Publication
(10) Pub. No.: US 2008/0157915 A1
(43) Pub. Date: Jul. 3, 2008

(54) Flame retardant, electrically-conductive pressure sensitive adhesive materials and methods of making the same

(76) Inventor: Ethan Lin, Sanchong City (TW)

Correspondence Address: Anthony G. Fussner, Suite 400, 7700 Bonhomme, St. Louis, MO, 63105, US

(21) Appl. No.: 11/649,324

(22) Filed: Jan. 3, 2007

(51) Int. Cl. H01F 27/36; C09K 21/00; B32B 5/02

(52) U.S. Cl. 336/84 C; 252/602; 442/110; 427/208.4; 252/610

(57) ABSTRACT

Halogen-free, flame retardant, electrically-conductive adhesive materials are disclosed herein, which may be suitable for use with electromagnetic interference shielding devices. In one embodiment the adhesive material may include an adhesive, electrically-conductive material dispersed throughout the adhesive, and flame retardant dispersed throughout the adhesive. The flame retardant may remain distinct from the electrically-conductive material, such that the flame retardant is also substantially free of coating by the electrically-conductive material.

### FIELD

The present disclosure relates generally to pressure sensitive adhesive materials, and more particularly to improved flame retardant, electrically-conductive pressure sensitive adhesive materials suitable for use with electromagnetic interference shielding devices.

### BACKGROUND

The statements in this section merely provide background information related to the present disclosure and may not constitute prior art.

During operation, electronic devices generate electromagnetic radiation within the electronic circuitry of the equipment. Such radiation may result in electromagnetic interference (EMI), which, in turn, may interfere with the operation of other electronic devices within a certain proximity. A common solution to ameliorate the effects of EMI has been the development of shields capable of absorbing and/or reflecting EMI energy. These shields are typically employed to localize EMI within its source, and to insulate other devices proximal to the EMI source.

As used herein, the term “EMI” should be considered to generally include and refer to EMI emissions and RFI emissions, and the term “electromagnetic” should be considered to generally include and refer to electromagnetic and radio frequency from external sources and internal sources. Accordingly, the term shielding (as used herein) generally includes and refers to EMI shielding and RFI shielding, for example, to prevent (or at least reduce) ingress and egress of EMI and RFI relative to a housing or other enclosure in which electronic equipment is disposed.

### SUMMARY

Halogen-free, flame retardant, electrically-conductive adhesive materials are disclosed herein, which may be suitable for use with electromagnetic interference shielding devices. In one exemplary embodiment, the adhesive material may include an adhesive, electrically-conductive material dispersed throughout the adhesive, and flame retardant dispersed throughout the adhesive. The flame retardant may remain distinct from the electrically-conductive material, such that the flame retardant is also substantially free of coating by the electrically-conductive material.

In another exemplary embodiment, a halogen-free, flame retardant, electrically-conductive pressure sensitive adhesive material generally includes a pressure sensitive adhesive layer and a substrate layer supporting the adhesive layer. The adhesive layer may include an acrylate-based pressure sensitive adhesive. Electrically-conductive material may be dispersed throughout the adhesive layer. The electrically-conductive material may have an average particle size less than about 0.20 millimeters. Flame retardant in particulate form may also be dispersed throughout the adhesive layer, such that the flame retardant is distinct from the electrically-conductive particles and substantially free of coating by the electrically-conductive particles. The flame retardant may include ammonium polyphosphate, melamine pyrophosphate, or a combination thereof.

Other aspects relate to methods of making halogen-free, flame retardant, electrically-conductive pressure sensitive adhesive materials. In one exemplary embodiment, a method generally includes preparing a pressure sensitive adhesive. The method may also include adding flame retardant in particulate form to the pressure sensitive adhesive. The method may further include adding electrically-conductive material in particulate form to the pressure sensitive adhesive without substantially coating the flame retardant with the electrically-conductive material. In some embodiments, the flame retardant includes ammonium polyphosphate particles, melamine pyrophosphate particles, or a combination thereof. The method may additionally include mixing the pressure sensitive adhesive, flame retardant, and electrically-conductive material, to thereby form a halogen-free, flame retardant, electrically-conductive pressure sensitive adhesive material.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic of an exemplary embodiment in which a flame retardant, electrically-conductive pressure sensitive adhesive (FR-C-PSA) material is applied to a substrate layer;

FIG. 2 is a schematic of another exemplary embodiment in which an FR-C-PSA layer is disposed between a substrate layer and an electrically-conductive pressure sensitive adhesive (C-PSA) layer;

FIG. 3 is a schematic of another exemplary embodiment in which FR-C-PSA material is immersed at least partially into at least a portion of an electrically-conductive fabric; and

FIG. 4 is a schematic of another exemplary embodiment in which FR-C-PSA material is bonding an electrically-conductive fabric to a foam core of an EMI shielding device.

### DETAILED DESCRIPTION

The following description is merely exemplary in nature and is not intended to limit the present disclosure, application, or uses. It should be understood that throughout the drawings, corresponding reference numerals indicate like or corresponding parts and features.

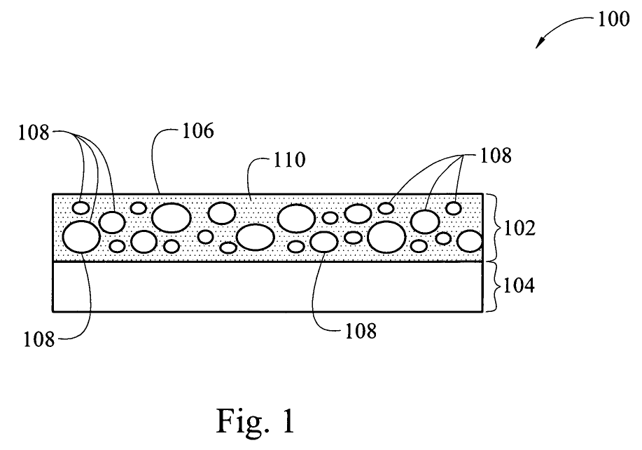

FIG. 1 schematically illustrates an exemplary embodiment of a halogen-free, flame retardant, electrically-conductive pressure sensitive adhesive (FR-C-PSA) material 100 in accordance with principles of the present disclosure. In various embodiments, the adhesive material 100 may advantageously offer electrically-conductive properties together with resistance to fire or flame retardance without using (or using very little) halogen-based substances (e.g., bromines, chlorines, etc.). With these qualities, the adhesive material 100 may thus be suitable for use with electromagnetic interference (EMI) shielding devices that are common in, for example, computers, personal digital assistants, cell phones, and other electronic devices.

As shown in FIG. 1, the adhesive material 100 generally includes an FR-C-PSA layer 102 applied to a substrate layer 104. The FR-C-PSA layer 102 includes pressure sensitive adhesive (PSA) 106, electrically-conductive material 108, and halogen-free, flame retardant 110.

A wide range of materials may be used for the PSA 106, including adhesive materials that are acrylate-based, rubber-based, silicone polymer based, etc. As one example, the PSA 106 comprises an acrylate-based material, which was converted from monomer (methyl acrylate, ethyl acrylate, butyl acrylate, isooctyl acrylate, acrylonitrile, etc.) into an oligomer or polymer. In this particular example, a drying process can be used for solvent evaporation. During the drying process, relatively minor cross-linking (but not really synthesis) may occur for some function groups of the polymer/oligomer. Most cross-linking, however, may occur after drying. For example, some embodiments include additional aging for a few days (e.g., one to fourteen days for some embodiments, etc.) such that most cross-linking is reacted during the aging process and not the drying process.

By way of further examples, the PSA 106 may comprise a synthetic or natural rubber, styrene butadiene rubber, styrene isoprene styrene rubber, silicone rubber, or an elastomer, or other resin, plastic, or polymer exhibiting rubber-like properties of compliancy, resiliency or compression deflection, low compression set, flexibility, and an ability to recover after deformation. The PSA 106 is shown in FIG. 1 is as part of the FR-C-PSA layer 102 in a substantially solid form. But prior to forming the FR-C-PSA layer 102, the PSA 106 is in a substantially fluid form for receiving electrically-conductive material 108 and flame retardant 110 in the PSA 106. While a PSA is described as receiving the flame retardant and electrically-conductive material, other adhesives may be used, for example, adhesives that are not pressure sensitive.

The electrically-conductive material 108 may also comprise any of a wide range of suitable materials. For example, the illustrated embodiment includes electrically-conductive nickel powder. In some embodiments, the nickel powder may be processed as necessary to the desired particle size and then added to the PSA 106. In other embodiments, however, the nickel powder may not need to be processed to obtain a desirable particle size. The nickel particles may have an average particle size of between about 0.0005 millimeters and about 0.1 millimeters, and may have a range of particle sizes between about 0.0001 millimeters and about 0.2 millimeters. In other exemplary embodiments, the electrically-conductive material may comprise, for example, copper powder, graphite, silver powder, silver coated copper powder, silver coated glass powder, or other conductive powder, other metals, alloys thereof, etc. Additional embodiments may have electrically-conductive particles having an average particle size less than 0.2 millimeters. In still other exemplary embodiments, the electrically-conductive material may have particles with sizes larger than 0.2 millimeters, or smaller than 0.0001 millimeter.

The flame retardant 110 is preferably formed from at least one or more of ammonium polyphosphate, melamine pyrophosphate, or combinations thereof. In some embodiments, the flame retardant 110 is in a particulate form, such as a powder.

The ammonium polyphosphate, melamine pyrophosphate, or combinations thereof may be processed as necessary to the desired particle size and then added to the PSA 106. In other embodiments, however, it may not be necessary to process the flame retardant 110 to obtain a desirable particle size.

In some embodiments, the flame retardant 110 comprises ammonium polyphosphate particles (e.g., powder, etc.) at least some of which have a particle size less than 0.1 millimeters. In one such embodiment, at least about ninety-five percent of the ammonium polyphosphate particles have a particle size less than 0.1 millimeters. In another such embodiment, at least some of the ammonium particles (e.g., a minority, a majority, a substantial majority, at least about ninety-five percent, etc.) have a particle size less than 0.05 millimeters.

In other embodiments, the flame retardant 110 comprises melamine pyrophosphate particles (e.g., powder, etc.) at least some of which have a particle size less than 0.1 millimeters. In one such embodiment, at least about ninety-five percent of the melamine pyrophosphate particles have a particle size less than 0.1 millimeters. In another such embodiment, at least some of the melamine pyrophosphate particles (e.g., a minority, a majority, a substantial majority, at least about ninety-five percent, etc.) have a particle size less than 0.05 millimeters.

Still further embodiments include a flame retardant 110 that is a combination of ammonium polyphosphate and melamine pyrophosphate particles (e.g., powder, etc.) at least some of which have a particle size less than 0.1 millimeters. In one such embodiment, at least about ninety-five percent of the ammonium polyphosphate particles and melamine pyrophosphate particles have a particle size less than 0.1 millimeters. In another such embodiment, at least some of the ammonium polyphosphate particles and melamine pyrophosphate particles (e.g., a minority, a majority, a substantial majority, at least about ninety-five percent, etc.) have a particle size less than 0.05 millimeters.

In various embodiments, both ammonium polyphosphate and melamine pyrophosphate, and any combinations thereof, may beneficially provide flame retardance or fire resistance to the PSA 106 without using halogen-based compounds and without impeding (or without significantly impeding) electrical conductivity provided by the electrically-conductive material 108. Ammonium polyphosphate and melamine pyrophosphate compounds may also offer an effective amount of flame resistance to enable EMI shielding devices to achieve a predetermined flame rating while at the same time having sufficient bond strength and retaining properties suitable (e.g., shielding effectiveness, bulk resistivity, etc.) for EMI shielding applications.

In one exemplary embodiment, the FR-C-PSA layer 102 is formed by adding electrically-conductive material 108 and flame retardant 110 in particulate form to the PSA 106, and then mechanically mixing to produce a FR-C-PSA mixture. The flame retardant particles 110 are preferably added separately from the electrically-conductive particles 108. This, in turn, helps the flame retardant particles 110 be substantially distinct from the electrically-conductive particles 108 in the FR-C-PSA mixture. Stated differently, the flame retardant particles 110 are substantially free of coating by the electrically-conductive material 108. Any acceptable mixing device may be used to mix the FR-C-PSA mixture, such as ball mill, sand mill, three-roll mill, stirrer, blade mixer, among other suitable mixing and stirring devices. In some exemplary embodiments, the FR-C-PSA mixture is mixed for about two hours. In other exemplary embodiments, the FR-C-PSA mixture may be mixed for a length of time (e.g., one half hour to five hours, etc.) depending, for example, on the particular mixing device, the materials, the desired thickness, etc. At completion of mixing, the solid flame retardant particles and solid electrically-conductive particles are dispersed substantially throughout or into the liquid adhesive. The resulting FR-C-PSA mixture in liquid form may have a medium viscosity (e.g., one hundred centipoises to about twenty thousand centipoises, etc.). In which case, the FR-C-PSA mixture in liquid form may thus be relatively easy to coat on a liner or other surface.

In this example, the FR-C-PSA mixture is still generally fluid in form such that further processing is needed in order to produce the substantially solid form FR-C-PSA layer 102 shown in FIG. 1.

In various embodiments, the FR-C-PSA mixture preferably comprises between about thirty and ninety percent by dry weight of PSA 106, between about two and thirty percent by dry weight of electrically-conductive material 108, and between about five and forty percent by dry weight of flame retardant 110. In one exemplary embodiments, the FR-C-PSA mixture may include about sixty-five percent by dry weight of PSA 106, about five percent by dry weight of electrically-conductive material 108, and about thirty percent by dry weight of flame retardant 110. In another exemplary embodiment, the FR-C-PSA mixture may comprise about fifty-three percent by dry weight of PSA 106, about seventeen percent by dry weight of electrically-conductive material 108, and about thirty percent by dry weight of flame retardant 110. In a further exemplary embodiment, the FR-C-PSA mixture may comprise about seventy percent by dry weight of PSA 106, about seven percent by dry weight of electrically-conductive material 108, and about twenty-three percent by dry weight of flame retardant 110. Alternative embodiments may include different amounts or percentages by dry weight of the PSA, electrically-conductive material, and flame retardant.

In some exemplary embodiments, the FR-C-PSA layer may also comprise one or more additives to help with dispersion of the flame retardant and electrically-conductive material in the FR-C-PSA mixture, and/or to increase adhesion properties of the resulting end-product adhesive material. For example, the FR-C-PSA layer may include one or more of a softener, antioxidant, plasticizer, curing agent, tackifier, coupling agent, pigment, dye, colorant, etc. In other embodiments, the FR-C-PSA layer may include a halogen-free corrosion inhibitor, such as benzotriazole or other suitable corrosion inhibitor selected, for example, from the azole family and/or pyrole family.

In one exemplary embodiment, the adhesive material 100 shown in FIG. 1 (and the substantially solid form FR-C-PSA layer 102 included therein) may be produced as follows. The fluid FR-C-PSA mixture may be coated or layered onto the substrate layer 104 (e.g., a base film, etc.) and dried in an oven. The heat from the oven facilitates or causes evaporation of any fluid carrier (e.g., water, solvents, etc.) from the PSA 106, thereby forming the generally solid form of the FR-C-PSA layer 102. By way of example only, the particular drying temperature (e.g., from about seventy degrees Celsius and about one hundred thirty degrees Celsius, etc.) and drying time (e.g., from about one minute to about ten minutes, etc.) may depend, for example, on the particular materials and drying mechanism (e.g., oven, etc.) used.

As can be seen in FIG. 1, the flame retardant particles 110 remain distinct from the electrically-conductive particles 108 after drying the FR-C-PSA mixture. In this particular example, the flame retardant particles 110 are thus substantially free of coating by the electrically-conductive material 108. In some embodiments, this may advantageously allow the flame retardant particles 110 to provide resistance to fire without impeding (or without significantly impeding) electrical conductivity provided by the electrically-conductive particles 108.

In some embodiments, the substrate layer 104 may include a metallic foil. In other embodiments, the substrate layer 104 may include a fabric backing. Examples of other suitable substrates include release liners (e.g., silicone release liners, etc.), tape backings (which may be primed or unprimed paper or plastic, etc.), crepe paper, cellophane, cellulose acetate, plasticized polyvinyl chloride, or any of a number of other flexible materials that may be reinforced with glass or other fibers, etc. In some exemplary embodiments, a primer coat may be used between the FR-C-PSA layer and substrate layer to help ensure good adhesion between the FR-C-PSA layer and substrate layer. The primer coat may based on natural or synthetic elastomers and may contain some tackifiers. In other exemplary embodiments, the adhesive material may include two or more layers of FR-C-PSA applied to the substrate layer.

By way of example, the following describes exemplary processes that may be employed for making FR-C-PSA layers. In one particular example, the PSA included between thirty percent and seventy-five percent (and more preferably forty-five percent and sixty-five percent) organic solvent or water and polymer. The PSA may be acrylate-based, rubber-based, silicone polymer based, etc. Flame retardant, electrically-conductive powder and other possible suitable additives were added into the solvent-based or water-based PSA. The dispersion of these additives within the PSA may be accomplished by using various types of mixing equipment for a length of time (e.g., a few hours, one half hour to five hours, etc.). In some embodiments, the flame retardant and electrically-conductive powder may be pre-mixed before adding to the PSA, for example, to facilitate or improve dispersion into the PSA.

The resulting FR-C-PSA liquid mixture may be coated or applied onto a base layer (e.g., release paper, plastic film, fabric, metal foil, etc.). After coating, a drying process (e.g., drying at a temperature of seventy to one hundred thirty degrees Celsius for one to ten minutes, etc.) may be performed to evaporate and remove the solvent or water from the mixture, such that the FR-C-PSA solidifies.

The solid FR-C-PSA layer may be laminated with one or more other layers and/or be coated with a second adhesive layer. The total thickness of the solid FR-C-PSA layer (inclusive or exclusive of the one or more other layers laminated thereto) may vary depending, for example, on the particular application intended for the FR-C-PSA. By way of example, some embodiments include a FR-C-PSA layer having a total thickness from about 0.015 millimeters and about 0.15 millimeters. Other embodiments include a FR-C-PSA layer having a total thickness from about 0.025 millimeters and 0.060 millimeters.

Some embodiments may also include an aging process during which the temperature of the FR-C-PSA is maintained (e.g., at room temperature, sixty degrees Celsius, etc.) for a length of time (e.g., few days, etc.). This aging process may increase cross-linking for some function group of the polymer adhesive, for example, to increase the adhesion properties thereof. As previously stated, achieving flame retardance and fire resistance with halogen-free material may be an important feature for some embodiments. To this end, various embodiments provide adhesive material as disclosed herein that are capable of successfully satisfying the flame-rating test outlined by the Underwriters Laboratories (UL) Standard No. 510, “Polyvinyl Chloride, Polyethylene, and Rubber Insulating Tape.” By way of background, the UL510 standard covers thermoplastic and rubber tapes for use as electrical insulation at not more than six hundred volts and at eighty degrees Celsius (one hundred seventy-six degrees Fahrenheit). It is understood that while the FR-C-PSA layer may include at least an effective amount of halogen-free flame retardant to achieve a predetermined UL510 flame rating, the FR-C-PSA layer may also include more or less than that effective amount. In various exemplary embodiments, the FR-C-PSA layer does not include more than a predetermined percentage by dry weight of the flame retardant, below which percentage the FR-C-PSA layer provides at least a predetermined bond strength. As recognized herein, some embodiments require a delicate balancing that should be maintained with the flame retardant and the FR-C-PSA layer. For example, if the FR-C-PSA layer contains too much flame retardant, the bond strength may be compromised. But if the adhesive does not include enough flame retardant, then it may not be able to meet a desired UL510 flame rating. In various exemplary embodiments, the FR-C-PSA layer includes at least an effective amount of flame retardant for providing a UL510 flame rating, but less than a predetermined percentage below which the FR-C-PSA layer provides at least a predetermined bond strength. Furthermore, the FR-C-PSA preferably includes enough flame retardant for providing a UL510 flame rating, but not so much that the FR-C-PSA is unable to maintain or retain z-axis conductivity or bulk resistivity sufficient for helping with grounding and/or EMI shielding applications. By way of example, various embodiments of the FR-C-PSA include an effective amount of flame retardant for providing a UL510 flame rating, while retaining z-axis conductivity or bulk resistivity (in the thickness direction) from about 0.05 ohm·cm. and about 0.5 ohm·cm.

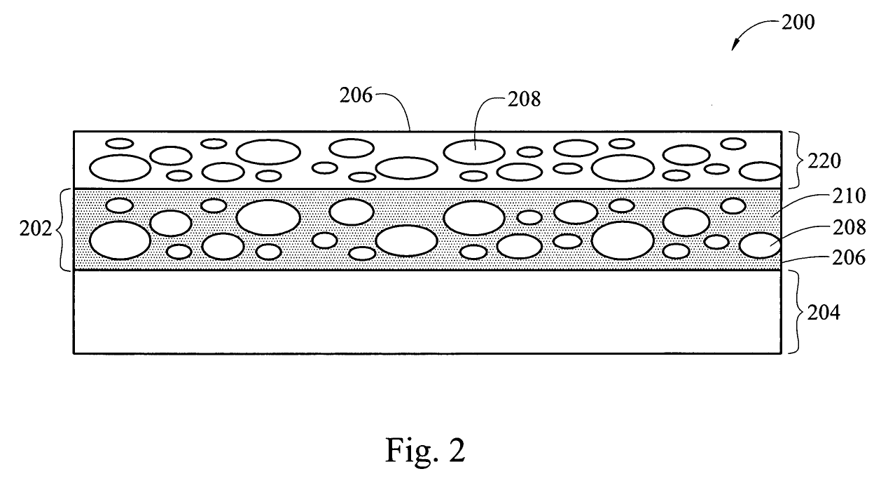

FIG. 2 illustrates an exemplary embodiment of an adhesive material 200 comprising a FR-C-PSA layer 202 formed from pressure sensitive adhesive (PSA) 206, electrically-conductive material 208, and halogen-free, flame retardant 210. It should be understood that features for this embodiment shown in FIG. 2 have been indicated with corresponding reference numbers (plus “100”) as the corresponding features of the adhesive material 100 illustrated in FIG. 1 and described above.

As shown in FIG. 2, the FR-C-PSA layer 202 is disposed generally between a substrate layer 204 and another layer 220. The layer 220 includes PSA 206 and electrically-conductive material 208, but does not include any flame retardant such that the layer 220 preferably has greater adhesion properties and bond strength than the FR-C-PSA 202. Accordingly, the layer 220 is hereafter generally referred to a C-PSA layer 220. As previously stated, flame retardant usually tends to compromise bond strength of an FR-C-PSA layer 202. The C-PSA layer 220 provides improved adhesion over the FR-C-PSA layer 202. Therefore, disposing the FR-C-PSA layer 202 between the substrate layer 204 and the C-PSA layer 220 improves overall adhesion of the adhesive material while retaining advantageous flame retardant or fire resistant properties of the FR-C-PSA layer 202.

In other embodiments, however, the layer 220 may also include some flame retardant. In such alternative embodiments, the amount of flame retardant in layer 220 may preferably be decreased as compared to the FR-C-PSA layer 202 such that the layer 220 has greater adhesion properties and bond strength than the FR-C-PSA 202. For example, the layer 220 may have no flame retardant or less flame retardant than the FR-C-PSA layer 202 such that the layer 220 has greater adhesion properties and bond strength than the FR-C-PSA 202.

In some embodiments, a tackifier may be used to improve the bond between the FR-C-PSA layer and the C-PSA layer. In other exemplary embodiments, the adhesive material may include one or more layers of FR-C-PSA, one or more layers of C-PSA, as well as one or more layers of PSA applied to the substrate layer. In other exemplary embodiments, the adhesive material may comprise one or more layers of FR-C-PSA along with one or more layers of C-PSA.

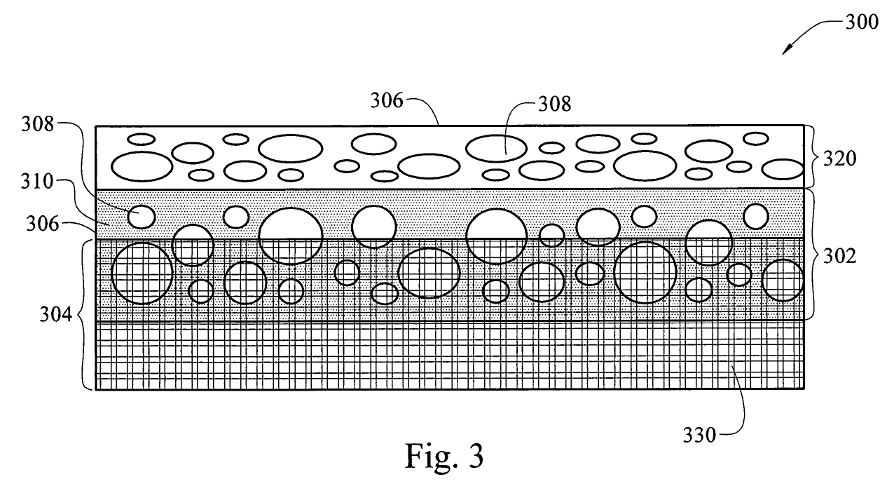

FIG. 3 illustrates another exemplary embodiment of an adhesive material 300. The adhesive material 300 comprises a FR-C-PSA layer 302 formed from pressure sensitive adhesive (PSA) 306, electrically-conductive material 308, and halogen-free, flame retardant 310. It should be understood that features for this embodiment shown in FIG. 3 have been indicated with corresponding reference numbers (plus “200”) as the corresponding features of the adhesive material 100 illustrated in FIG. 1 and described above.

The FR-C-PSA layer 302 is disposed generally between a substrate layer 304 and another layer 320. The layer 320 includes PSA 306 and electrically-conductive material 308, but does not include any flame retardant. Accordingly, the layer 320 is hereafter generally referred to a C-PSA layer 320.

In this particular embodiment, the substrate layer 304 may also function as a backing layer. The layer 304 comprises a metallized, electrically-conductive fabric 330. The metal forming the fabric 330 may be copper, nickel, silver, palladium aluminum, tin, alloys, and/or combinations thereof. The layer 330 may also comprise a metal mesh or a metal-plated fabric. In some embodiments, the FR-C-PSA mixture is preferably applied to the fabric 330 by a lamination process using a twin-roll type laminator to immerse the FR-C-PSA mixture in the fabric, thereby improving flame resistance of the fabric. The temperature and pressures used for the lamination process may vary depending, for example, on the particular materials used. The FR-C-PSA mixture may be dried in an oven to evaporate the liquid carrier of the PSA. In some embodiments, an additional backing layer (not shown) may be provided for supporting the electrically-conductive fabric 330 immersed with the FR-C-PSA layer 302. Depending on the particular application, this FR-C-PSA coated fabric may be used in place of more expensive flame retardant fabrics currently available.

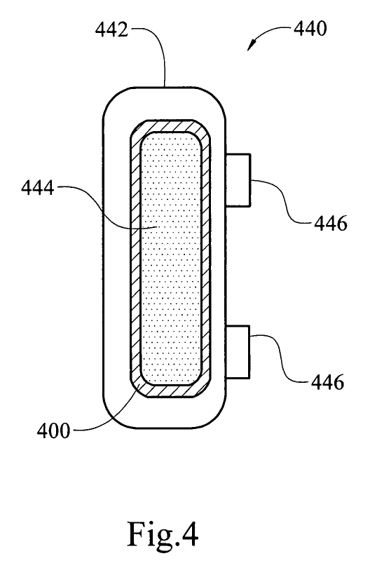

FIG. 4 illustrates another exemplary embodiment in which an EMI shielding device 440 (e.g., an EMI gasket, etc.) utilizes adhesive material 400 as disclosed herein. It should be understood that features for this embodiment shown in FIG. 4 have been indicated with corresponding reference numbers (plus “300”) as the corresponding features of the adhesive material 100 illustrated in FIG. 1 and described above.

As shown in FIG. 4, adhesive material 400 is disposed so as to help bond an electrically-conductive layer 442 to a resilient core member 444 to thereby form the EMI shielding device (e.g., fabric over foam shielding device, etc.). Alternative adhesive materials may also or instead be used to help bond the electrically-conductive layer to the resilient core member 444.

With continued reference to FIG. 4, the electrically-conductive layer 442 may also be immersed with the adhesive material 400, such as by an exemplary process described above. In addition, one or more adhesive strips 446 may also be used for attaching the EMI shielding device 440 to external structure. The adhesive strips 446 may include the adhesive material 400 and/or another suitable adhesive.

A wide range of materials may be used for the core member 444. In one example, embodiment, the core member is made of urethane foam having a polyester film scrim attached thereto. Alternative materials may be used for the resilient core member, such as elastomers, foams, among other resiliently compressible materials that are suitable for compression within an opening or gap. Other materials and types may also be used for the scrim including fabrics. Yet other embodiments do not have a scrim attached to the resilient core member. In various embodiments, the core member may also be provided with flame retardant. For example, various embodiments include a resilient core member provided with (e.g., immersed or impregnated with, etc.) adhesive material.

A wide range of materials may also be used for the electrically-conductive layer 442. Exemplary materials include conductive fillers within a layer, a metal layer, and/or an electrically-conductive non-metal layer. In some embodiments, the electrically-conductive layer comprises a metallized or plated fabric in which the metal is copper, nickel, silver, palladium aluminum, tin, alloys, and/or combinations thereof. For example, one particular embodiment includes a nickel copper nylon ripstop (NRS) fabric. In other embodiments, the electrically-conductive layer may comprise a layer of material that is impregnated with a metal material to thereby render the layer sufficiently electrically-conductive for EMI shielding applications. The particular material(s) used for the electrically-conductive layer may vary, for example, depending on the desired electrical properties (e.g., surface resistivity, electrical conductivity, etc.), which, in turn, can depend, for example, on the particular application in which the EMI shield will be used.

In other exemplary embodiments, a method may be provided for making a halogen-free, flame retardant, electrically-conductive pressure sensitive adhesive material suitable for use with electromagnetic interference shielding devices. In one exemplary embodiment, a method generally includes preparing a FR-C-PSA mixture by adding flame retardant in particulate form and electrically-conductive material in particulate form to a PSA. The flame retardant may include at least one or more of ammonium polyphosphate, melamine pyrophosphate, or a combination thereof. The electrically-conductive material may preferably be added so as not to substantially coat the flame retardant with electrically-conductive material. The mixture of PSA, flame retardant, and electrically-conductive material may then be mixed to form the FR-C-PSA mixture. In other embodiments, the FR-C-PSA mixture may be coated or layered onto a base film. In still other exemplary embodiments, the FR-C-PSA mixture may be dried in an oven to facilitate or cause evaporation of the liquid carrier of the PSA. In other exemplary embodiments, the FR-C-PSA mixture may be applied to a fabric backing by a lamination process using a twin-roll type laminator. The fabric backing and FR-C-PSA mixture may then be dried in an oven to facilitate or cause evaporation of the liquid carrier of the PSA.

As used herein, the term “layer” or “layers” (e.g., FR-C-PSA layer, substrate layer, etc.) is not intended to limit the description to any particular set forms, shapes, or configurations. It is instead done to distinguish different features of the adhesive material. Therefore, the terms “layer” or “layers” should not be read as limitations herein. In addition, the terms “fire resistant”, “fire retardant”, “flame resistant”, and “flame retardant” are used interchangeably herein. These terms are intended to have corresponding meanings, and use of one instead of the other is not intended as a limitation.

Certain terminology is used herein for purposes of reference only, and thus is not intended to be limiting. For example, terms such as “upper”, “lower”, “above”, “below”, “top”, and “bottom” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

The description of the disclosure is merely exemplary in nature and, thus, variations that do not depart from the gist of the disclosure are intended to be within the scope of the disclosure. Such variations are not to be regarded as a departure from the spirit and scope of the disclosure.

What is claimed is:

1. A halogen-free, flame retardant, electrically-conductive adhesive material suitable for use with electromagnetic interference shielding devices, the adhesive material comprising:
an adhesive;
electrically-conductive material dispersed throughout the adhesive;
flame retardant dispersed throughout the adhesive, the flame retardant being distinct from the electrically-conductive material and substantially free of coating by the electrically-conductive material.

2. The adhesive material of claim 1, wherein the flame retardant comprises at least one or more of ammonium polyphosphate in particulate form, melamine pyrophosphate in particulate form, or a combination thereof.

3. The adhesive material of claim 2, wherein at least some of the flame retardant in particulate form have a particle size of less than about 0.1 millimeters.

4. The adhesive material of claim 2, wherein at least about ninety-five percent of the flame retardant in particulate form have a particle size less than about 0.1 millimeters.

5. The adhesive material of claim 2, wherein at least some of the flame retardant in particulate form have a particle size of less than about 0.05 millimeters.

6. The adhesive material of claim 2, wherein at least about ninety-five percent of the flame retardant in particulate form have a particle size less than about 0.05 millimeters.

7. The adhesive material of claim 1, wherein the adhesive material comprises between about thirty and ninety percent by dry weight of adhesive, between about two and thirty percent by dry weight of electrically-conductive material, and between about five and forty percent by dry weight of flame retardant.

8. The adhesive material of claim 1, wherein the adhesive material comprises about sixty-five percent by dry weight of adhesive, about five percent by dry weight of electrically-conductive material, and about thirty percent by dry weight of flame retardant.

9. The adhesive material of claim 1, wherein the adhesive material comprises about fifty-three percent by dry weight of adhesive, about seventeen percent by dry weight of electrically-conductive material, and about thirty percent by dry weight of flame retardant.

10. The adhesive material of claim 1, wherein the adhesive material comprises about seventy percent by dry weight of adhesive, about seven percent by dry weight of electrically-conductive material, and about twenty-three percent by dry weight of flame retardant.

11. The adhesive material of claim 1, wherein:
the adhesive is acrylate-based;
the electrically-conductive material comprises nickel powder; and
the flame retardant comprises at least one or more of ammonium polyphosphate in particulate form, melamine pyrophosphate in particulate form, or a combination thereof.

12. The adhesive material of claim 11, wherein the nickel powder in particulate form have an average particle size of between about 0.0005 millimeters and about 0.1 millimeters.

13. The adhesive material of claim 1, further comprising a substrate layer to which are applied the adhesive, electrically-conductive material, and flame retardant.

14. The adhesive material of claim 13, wherein the adhesive, electrically-conductive material, and flame retardant define a first layer disposed generally between the substrate layer and a second layer comprising adhesive, the second layer including less flame retardant than the first layer such that the second layer has a greater bond strength than the first layer.

15. The adhesive material of claim 1, wherein the adhesive material is substantially free of halogen-based materials.

16. The adhesive material of claim 1, wherein the adhesive is a pressure sensitive adhesive.

17. An electromagnetic interference (EMI) shielding device including the adhesive material of claim 1, and further comprising a resilient core member and an outer electrically-conductive layer bonded to the resilient core member.

18. An electrically-conductive fabric having the adhesive material of claim 1 immersed at least partially into at least a portion of the electrically-conductive fabric, whereby flame retardance of the electrically-conductive fabric is increased.

19. The adhesive material of claim 1, wherein the adhesive material has a z-axis resistivity between about 0.005 ohm·cm and 0.5 ohm·cm.

20. The adhesive material of claim 1, wherein the adhesive material includes an effective amount of flame retardant that provides the adhesive material with a UL510 flame rating.

21. The adhesive material of claim 1, wherein the adhesive material has a UL510 flame rating and z-axis resistivity between about 0.005 ohm·cm and 0.5 ohm·cm.

22. The adhesive material of claim 1, wherein the adhesive material includes an effective amount of flame retardant that provides the adhesive material with a UL510 flame rating while at the same time retaining z-axis resistivity sufficient for establishing electrically-conductive grounding suitable for EMI shielding applications.

23. The adhesive material of claim 1, wherein the flame retardant comprises at least one or more of ammonium polyphosphate powder, melamine pyrophosphate powder, or a combination thereof.

24. A halogen-free, flame retardant, electrically-conductive pressure sensitive adhesive material suitable for use with electromagnetic interference shielding devices, the adhesive material comprising:
a pressure sensitive adhesive layer including:
an acrylate-based pressure sensitive adhesive;
electrically-conductive material in particulate form having an average particle size less than about 0.20 millimeters and dispersed throughout the adhesive layer;
flame retardant in particulate form dispersed throughout the adhesive layer, the flame retardant being distinct from the electrically-conductive particles and substantially free of coating by the electrically-conductive particles, the flame retardant comprising at least one or more of ammonium polyphosphate, melamine pyrophosphate, or a combination of ammonium polyphosphate and melamine pyrophosphate;
a substrate layer supporting the adhesive layer.

25. The adhesive material of claim 24, wherein the adhesive layer comprises between about thirty and ninety percent by dry weight of acrylate-based pressure sensitive adhesive, between about two and thirty percent by dry weight of electrically-conductive material, and between about five and forty percent by dry weight of flame retardant.

26. The adhesive material of claim 24, wherein the adhesive layer comprises about sixty-five percent by dry weight of acrylate-based pressure sensitive adhesive, about five percent by dry weight of electrically-conductive material, and about thirty percent by dry weight of flame retardant.

27. The adhesive material of claim 24, wherein the adhesive layer comprises about fifty-three percent by dry weight of acrylate-based pressure sensitive adhesive, about seventeen percent by dry weight of electrically-conductive material, and about thirty percent by dry weight of flame retardant.

28. The adhesive material of claim 24, wherein the adhesive layer comprises about seventy percent by dry weight of acrylate-based pressure sensitive adhesive, about seven percent by dry weight of electrically-conductive material, and about twenty-three percent by dry weight of flame retardant.

29. The adhesive material of claim 24, wherein the adhesive material has a z-axis resistivity between about 0.005 ohm·cm and 0.5 ohm·cm.

30. The adhesive material of claim 24, wherein the adhesive material includes an effective amount of flame retardant that provides the adhesive material with a UL510 flame rating.

31. The adhesive material of claim 24, wherein the flame retardant comprises at least one or more of ammonium polyphosphate powder, melamine pyrophosphate powder, or a combination thereof.

32. A method for making a halogen-free, flame retardant, electrically-conductive pressure sensitive adhesive material suitable for use with electromagnetic interference shielding devices, the method comprising:
preparing a pressure sensitive adhesive;
adding flame retardant in particulate form to the pressure sensitive adhesive, the flame retardant including at least one or more of ammonium polyphosphate, melamine pyrophosphate, or a combination thereof;
adding electrically-conductive material in particulate form to the pressure sensitive adhesive without substantially coating the flame retardant with the electrically-conductive material; and
mixing the pressure sensitive adhesive, flame retardant, and electrically-conductive material. to thereby form a halogen-free, flame retardant, electrically-conductive pressure sensitive adhesive material.

33. The method of claim 32, further comprising after mixing, applying the adhesive material to a substrate layer.

34. The method of claim 32, further comprising after mixing, drying the adhesive material.

35. The method of claim 32, further comprising after mixing, immersing a fabric material into the adhesive material to thereby coat at least a portion of the fabric material with the adhesive material.

36. The method of claim 32, wherein the flame retardant comprises at least one or more of ammonium polyphosphate powder, melamine pyrophosphate powder, or a combination thereof.
